(19) United States
(12) Patent Application Publication
(10) Pub. No.: US 2014/0283489 A1
(43) Pub. Date: Sep. 25, 2014

(54) Chain Link, Chain Conveyor, Filling Machine, and Package-Flap Folding Method

(71) Applicant: Taizhou Zhuye Machinery Technology CO.,LTD, Taizhou (CN)

(72) Inventor: Shuanghai Zhu, Ningbo (CN)

(21) Appl. No.: 14/296,482

(22) Filed: Jun. 5, 2014

Related U.S. Application Data
(63) Continuation of application No. PCT/CN2012/085931, filed on Dec. 5, 2012.

(30) Foreign Application Priority Data
Dec. 5, 2011 (CN) 201110397843.6
Dec. 6, 2011 (CN) 201110398829.8
Dec. 7, 2011 (CN) 201110402326.3

(51) Int. Cl. B65G 17/12; B65B 51/00; B65B 3/02

(52) U.S. Cl. CPC B65G 17/12; B65B 3/02; B65B 51/00
USPC 53/491; 198/469.1

(57) ABSTRACT

Disclosed are a chain link, a chain conveyor, a filling machine, and a package-flap folding method. The chain conveyor comprises a hinge part and a support part; the support part is fastened with a blade for clamping and pushing a package; the blade divides the support part into a rectangular front support part and a rear support part; multiple chain links can be hinged to form an annular chain, and the distance between the blades of two neighboring chain links in a straight line segment equals to the width of the package; the length of the support surface of the front support part equals to or is slightly smaller than the distance between an flap at the end to the rear side surface of the package; the rear end surface of the rear support part forms the guiding surface for guiding the folding of the flap at the end.

### TECHNICAL FILED

The present invention relates to a chain link for a chain conveyor, in particular to a chain link for a chain conveyor for conveying a package unit having an flap at the end and folding the flap at the end onto an end wall of the package to form a package.

The present invention also relates to a chain conveyor, in particular to a chain conveyor in form of an annular chain formed by a plurality of chain links hinged together.

The present invention also relates to a filling machine, in particular to a filling machine having a chain conveyor.

The present invention also relates to a package folding method, in particular to a method for folding a flap at a bottom end of the package.

### BACKGROUND

At present, there are many foods, such as milk, beverage and fruit juice and others, which may be filled into packages made of sterilized packaging material for sale. A typical example of such packages is a parallelepiped-shaped package formed by folding and sealing strip laminated packaging material. The package is manufactured by an automatic filling machine (also called packaging machine), and the strip packaging material are sterilized in the filling machine such as by applying chemical disinfectants, for example, hydrogen peroxide solution which is then removed after sterilization, for example, evaporated from the surface of the packaging material by heating. The sterilized packaging material are kept in a closed, sterilized environment, and folded longitudinally and sealed to form a vertical tube. The packaging material tube is then filled with food as an object to be packaged, sealed along a transversal part spaced equally and then cut along the transversal part into a plurality of pillowed packages 3 (as shown in FIG. 1). Then, the pillowed packages 3 are fed to a folding device where the pillowed packages 3 are mechanically folded to form corresponding packages, for example, substantially parallelepiped-shaped packages.

As shown in FIG. 1 and FIG. 2, the package 3 has a longitudinal sealing strip 4 extending along one side of each package 3, and the opposite end parts of the package are sealed by corresponding transverse sealing strips 5 and 6 which are perpendicular to and connected to the longitudinal strip 4. The package 3 has an axis parallel to the longitudinal sealing strip 4, and comprises a parallelepiped-shaped main part 7, and an opposite top end 8 and a bottom end 9 tapering towards the corresponding transverse sealing strips 5 and 6 from the main part 7, respectively. More specifically, the main part 7 of each package 3 is laterally limited by two planar rectangular walls 10 parallel to each other and also to the axis and two planar rectangular walls 11 extending vertically between the two planar rectangular walls 10. Each one of the end parts 8 and 9 is defined by a pair of substantially isosceles trapezoid walls 12. The pair of walls 12 slightly tilt facing each other with respect to a plane perpendicular to axis A, and have a rectangular edge defined by corresponding edges of the walls 10 of the main part 7 and a long edge connected by corresponding sealing strips 5 and 6. The longitudinal sealing strip 4 extends between the transverse sealing strips 5 and 6, and also extends along one of the whole planar rectangular walls 10 and a corresponding wall 12 on the same side with the planar rectangular walls 10. Each of the transverse sealing strips 5 and 6 forms corresponding rectangular flaps at the ends 13 and 14 which are substantially elongated, the flaps at the ends 13 and 14 are protruded from the corresponding package 3 along the direction of the axis A; and forms two substantially triangular folded wings 15 and 16, which are protruded laterally from opposite sides of the main part 7 and defined by ends of the corresponding wall 12. In order to form a packaging container, the opposite end parts 8 and 9 of the package 3 are pressed towards each other by the folding device downward, and the corresponding flaps at the ends 13 and 14 are folded onto the end parts 8 and 9.

Chinese Invention Patent No. CN100556760C disclosed a folding unit for a pourable food product packaging machine, as shown in FIG. 3 and FIG. 4, for manufacturing a pourable food product packaging container 2 from a sealed package 3, the packaging container 2 having a longitudinal axis A and at least one flap at the end 14 to be folded, the flap at the end 14 protruding in the direction of the aforementioned axis. The folding unit 1 has at least one conveying member 35 or 28 that passes through an end part opposite to the flap at the end 14, cyclically receives a corresponding package 3 in a feed direction C coaxial to the longitudinal axis A, and feeds the package 3 along a forming path B crisscross to the longitudinal axis A of the package 3; and a folding mechanism 24 that interacts with each package 3 along the forming path B in order to fold the corresponding flap at the end 14 onto the bottom end 9 of the package 3. The folding mechanism 24 comprises movable plates 42, each one of which has two pins 49 laterally protruding outward from the opposite sides of the movable plates 49. The movable plates 42 define a shock surface 43 that receives each package 3 through the end part opposite to the flap at the end 14. The shock surface 43 is borne by the conveying member 35 or 28 in order to move between a first running position where the shock surface 43 and the feed direction C of the corresponding package 3 form an angle of above 90° opening towards the forming path B direction, so that the relative flap at the end 14 is folded onto the package 3 in the traveling direction of the package along the forming path B according to the shock to the relative flap at the end 14, and a second running position where the shock surface 43 turns around towards the package 3 and cooperates with the package 3 to achieve the folding of the relative flap at the end 14 onto the package 3. The conveying member 35 of the folding unit belongs to a chain link for a chain conveyor. During feeding the package from the feed position to the output position, the shock surface of the folding mechanism on the conveying member 35 folds the flap at the end onto the end part. However, since the mechanism providing the folding mechanism on the conveying member is complex and the flap at the end is folded forward onto the end part, during the operation of forming the folded wings as the package runs forward, the folded flap at the end tends to interact with the folding device to be turned up to affect the subsequent operation, thus to affect the forming effect of the package.

### SUMMARY OF THE INVENTION

The technical problem of the present invention to be solved is to provide a chain link for a chain conveyor. An annular chain, formed of chain links hinged, folds the flap at the end of the package backward onto the end part during the feeding of the package from the feeding position to the output position, to ensure that the flap at the end will not be turned up in the subsequent folding of the folded wings, in order to achieve smooth folding of the folded wings and realize good forming effect.

In order to solve the above technical problem, the present invention provides a chain link for a chain conveyor, comprising a hinge part for hinging and a support part fastened onto the hinge part for supporting the package. The support part is fastened with a blade for clamping and pushing the package. The blade divides the support part into a rectangular front support part and a rear support part. Multiple chain links are able to be hinged to form an annular chain, with the distance between the blades of two neighboring chain links in a straight line segment equaling to the width of the package L. The length of the support surface of the front support part L5 equals to or is slightly smaller than the distance between the flap at the end and the rear side surface of the package L1. The rear end surface of the rear support part forms a guiding surface for guiding the folding of the flap at the end.

Comparing the chain link of the present invention with that in the prior art, as the length of the support surface of the front support part L5 equals to or is slightly smaller than the distance between the flap at the end and the rear side surface of the package L1, after the chain links form the annular chain and the package is fed from the provision platform, the package is supported by the blade of the next chain link and its flap at the end can enter into the gap between the chain links, and during the movement along with the chain link from the C-shaped part to the linear top branch, the blade of the next chain link pushes the package closer to the blade of the previous chain link, and the rear end surface of the rear support part forms a guiding surface for guiding the folding of the flap at the end to allow the withdrawing of the flap at the end from the gap and folding the flap at the end backward onto the end part. Therefore, the present invention does not require any additional members or devices. The folding of the flap at the end on the folding part can be accomplished just by the chain links themselves. The structure is simple.

The present invention further provides a chain conveyor, comprising the aforementioned chain link.

The present invention also provides a filling machine having the aforementioned chain conveyor.

The present invention also provides a method for folding a flap at the bottom end of the package, comprising an annular chain formed of multiple chain links hinged, the annular chain comprising a horizontal linear top branch and bottom branch and two bent C-shaped parts, the C-shaped parts being located at two end parts of the top branch and the bottom branch respectively, and the middle parts of the C-shaped parts defining a provision platform and an output platform respectively, the method comprising the following steps: A. a package having an flap at the end is fed from the provision platform, and the flap at the end is allowed to enter into a gap between two neighboring chain links; B. the annular chain is turned around, and the blade of the next chain link pushes the package to move towards the top branch, such that: C. a guiding member on the C-shaped part at the provision platform flattens the end part of the package; and D. the rear end surface of the rear support part gradually guides the flap at the end to be folded onto the end part.

### BRIEF DESCRIPTION OF THE DRAWINGS

FIG. 1 is a three-dimensional schematic view of a package before folded.

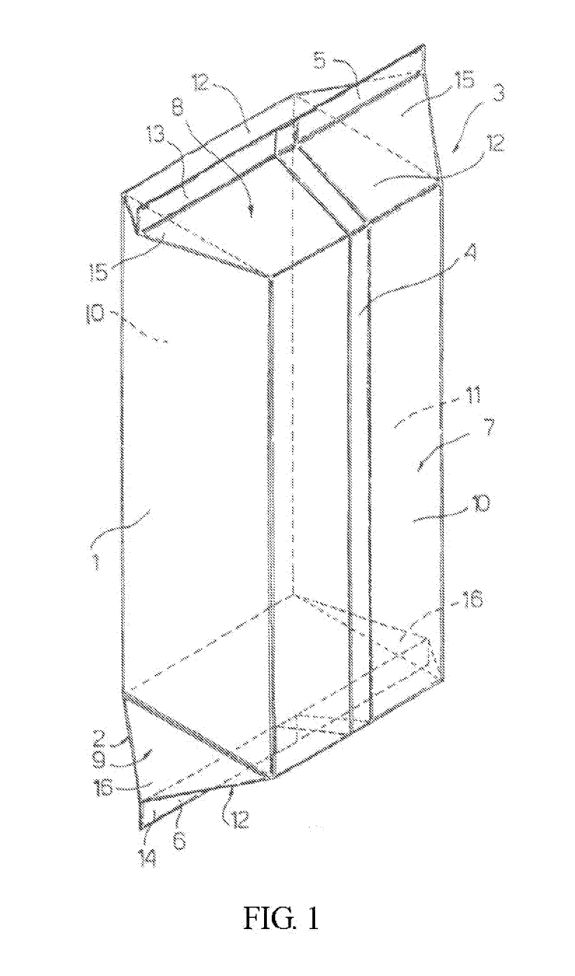

FIG. 2 is a side schematic view of FIG. 1.

FIG. 3 is a schematic view of a chain link for a chain conveyor in the prior art.

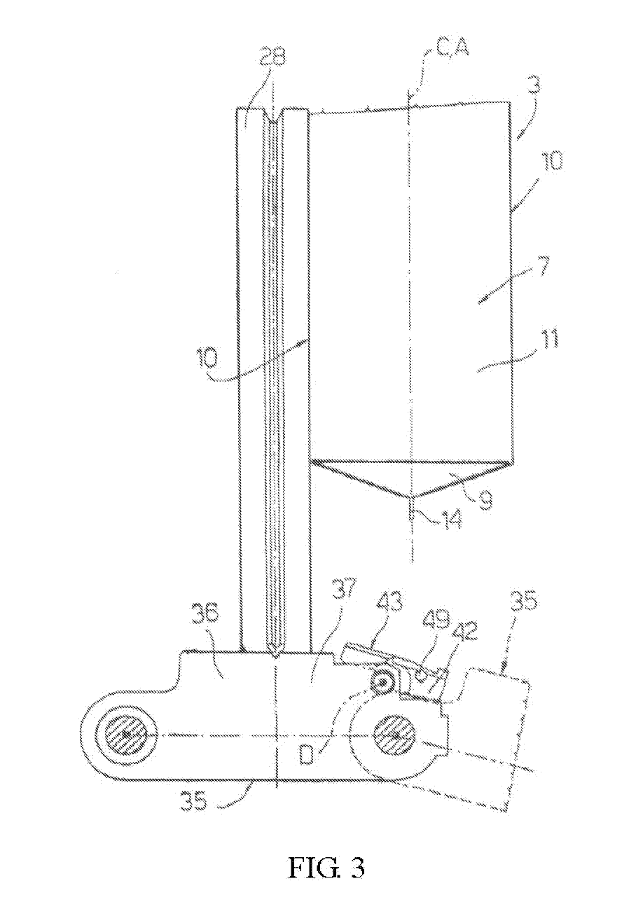

FIG. 4 is a schematic view of a chain conveyor formed of the chain links hinged of FIG. 3.

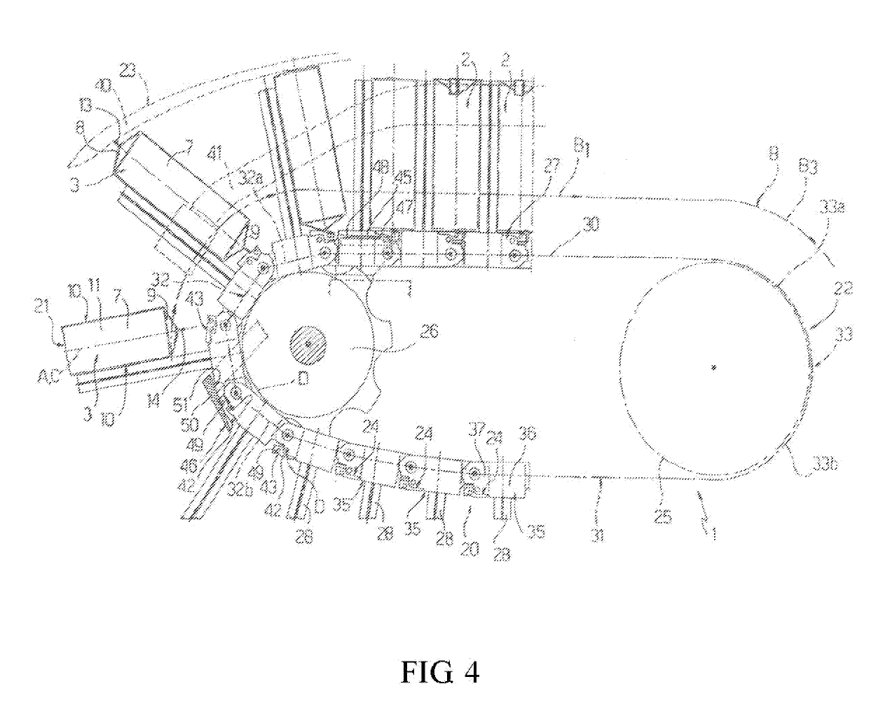

FIG. 5 is a schematic view of a first chain link for a chain conveyor according to the present invention.

FIG. 6 is a schematic view of a chain conveyor formed of the chain links hinged of FIG. 5.

FIG. 7 is a schematic view of a second chain link for a chain conveyor according to the present invention.

FIG. 8 is schematic view of a state of feeding the package from a provision platform.

FIG. 9 is schematic view of a state of an flap at the end of the package entering into a gap between chain links.

FIG. 10 is a schematic view of a state of folding the flap at the end of the package.

FIG. 11 is a schematic view of a state of folding the flap at the end of the package onto an end part.

### DETAILED DESCRIPTION OF THE INVENTION

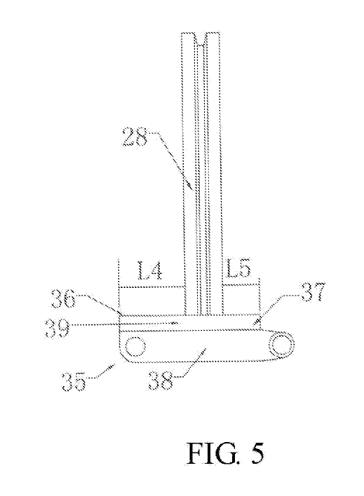

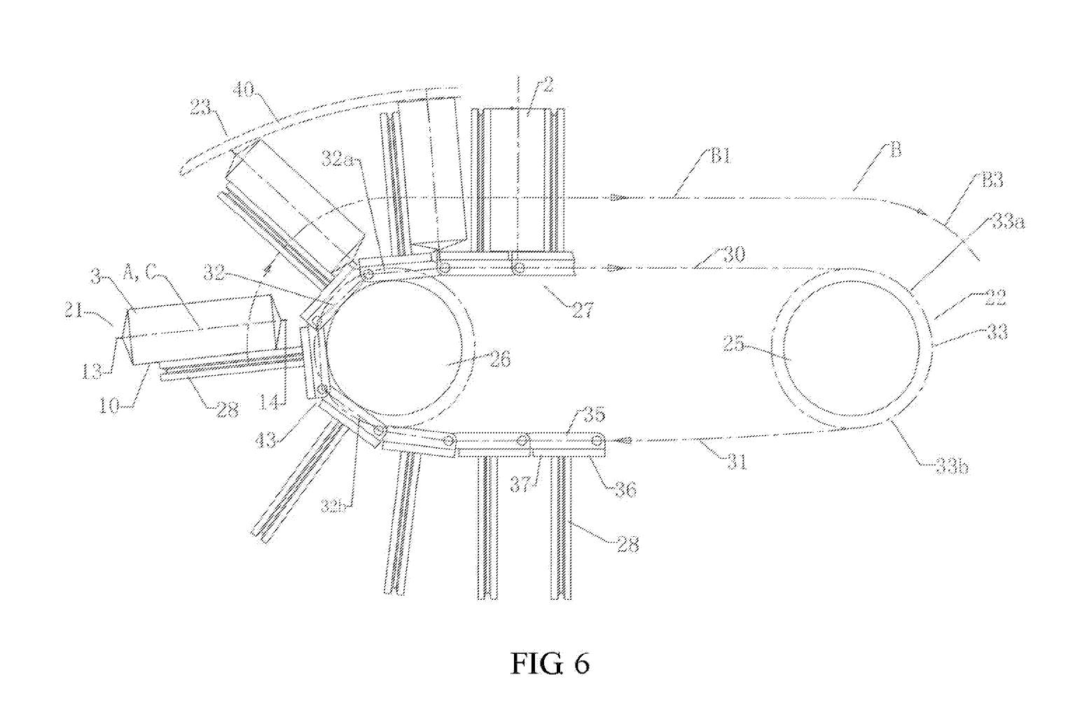

Referring to FIG. 5 and FIG. 6, a preferred embodiment of the present invention is an annular chain 27 formed of hinged chain links 35 for a chain conveyor, used for feeding a package 3 from a provision platform 21 to an output platform 22 (both shown schematically). continually along a substantially horizontal linear forming path B.

The chain conveyor comprises a drive gear 25, a driven gear 26 and the annular chain 27; and the annular chain 27 is an annular chain formed of multiple chain links 35 hinged together, and surrounds and meshes with the drive gear 25 and the driven gear 26.

The annular chain 27 comprises a horizontal linear top branch 30, a bottom branch 31 substantially parallel to the top branch 30, and two bent C-shaped parts 32 and 33 located at the two ends of the top branch 30 and the bottom branch 31 respectively, and configured to allow a concave surface thereof facing the top branch 30 and the bottom branch 31. The chain links on the top branch 30 and the bottom branch 31 are hinged to form the annular chain. The middle parts of the C-shaped parts 32 and 33 define the provision platform 21 and the output platform 22 respectively.

The path B comprises a linear main part B1 defined by the top branch 30 of the annular chain 27, and a corresponding provision end B2 and an output end B3 defined by relative tops 32a and 33a of the C-shaped parts 32 and 33, the tops 32a and 33a extending between the relative provision platform 21 and output platform 22 and the top branch 30. The top 32a of the C-shaped part 32, the top branch 30 and the top 33a of the C-shaped part 33 define a conveying part of the annular chain 27 to feed the package 3 from the provision platform 21 to the output platform 22, while the remaining part 32b of the C-shaped part 32, the bottom branch 31 and the remaining part 33b of the C-shaped part 33 define a returning part of the annular chain 27 to allow the chain link 35 to be returned from the output platform 22 to the provision platform 21, so that the annular chain 27 operates circularly to constantly feed the package 3 from the provision platform 21 to the output platform 22. The flap at the end 14 at the bottom end of the package 3 is folded onto the end part 9, and the flap at the end 13 at the top end of the package 3 is folded onto the end part 8 under the effect of the guiding member 40 of the folding device 23.

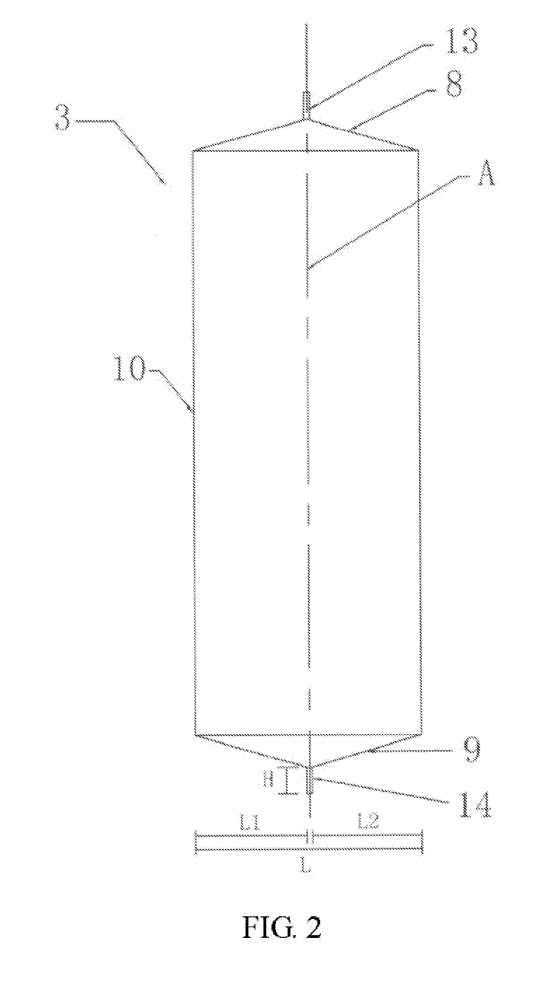

The chain link 35 comprises a hinge part 38 for hinging and a support part 39 fastened onto the hinge part 38 for supporting the package 3. The outside surface of the support part 39 is a flat rectangular surface that forms a support surface for supporting the package 3, a blade 28 is fastened on the support surface for clamping and pushing the package 3. The blade 28 is used for clamping the planar rectangular walls 10 of the package 3 and pushing the package 3, so as to feed the package along the path B. At the top branch 30 in the straight line segment, the distance between the blades 28 of two neighboring chain links 35 equals to the width of the package 3 L (the distance between the planar rectangular walls 10 of the package 3 as shown in FIG. 2).

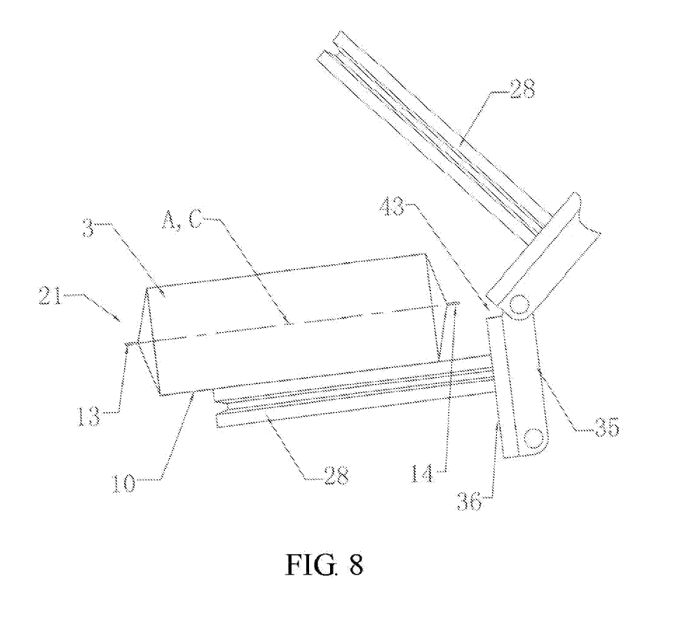

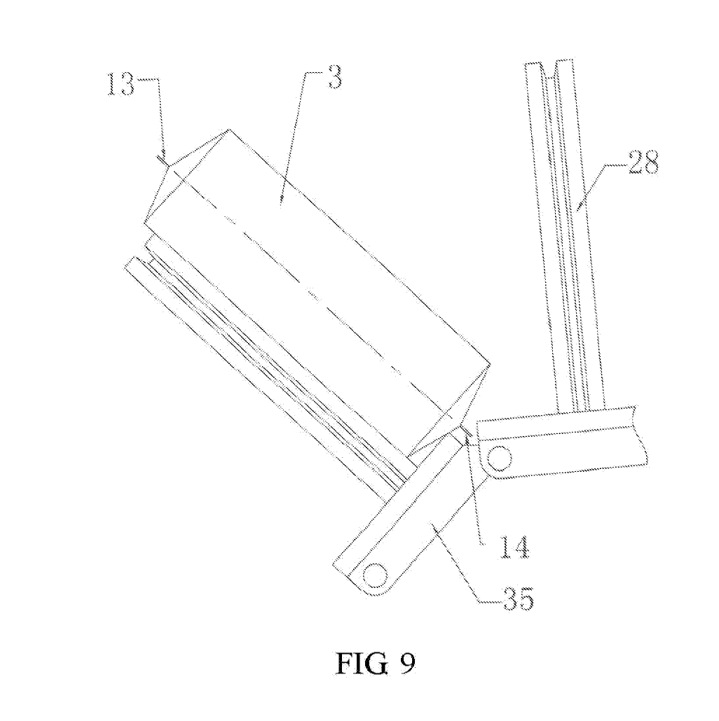

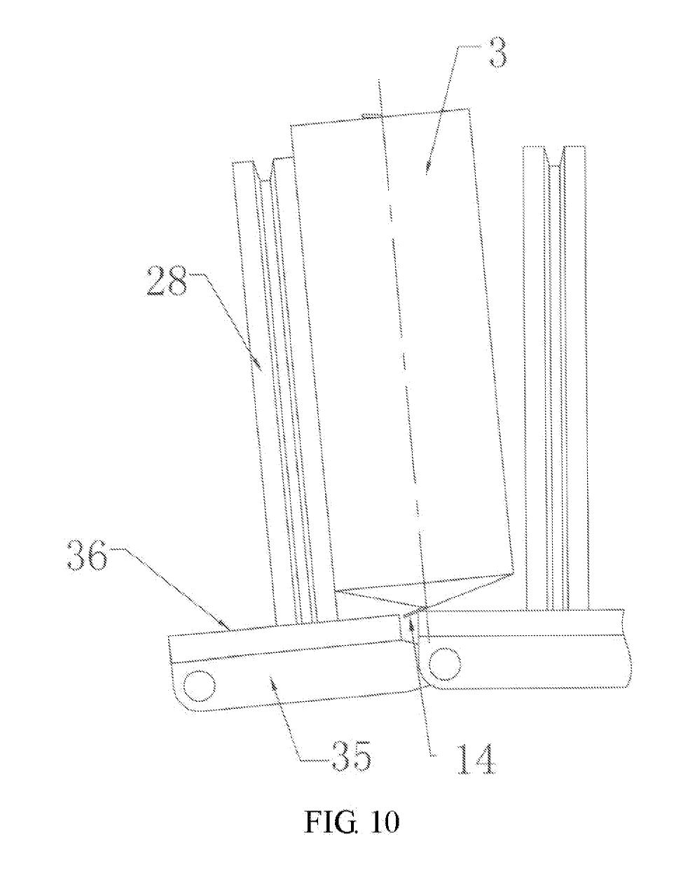

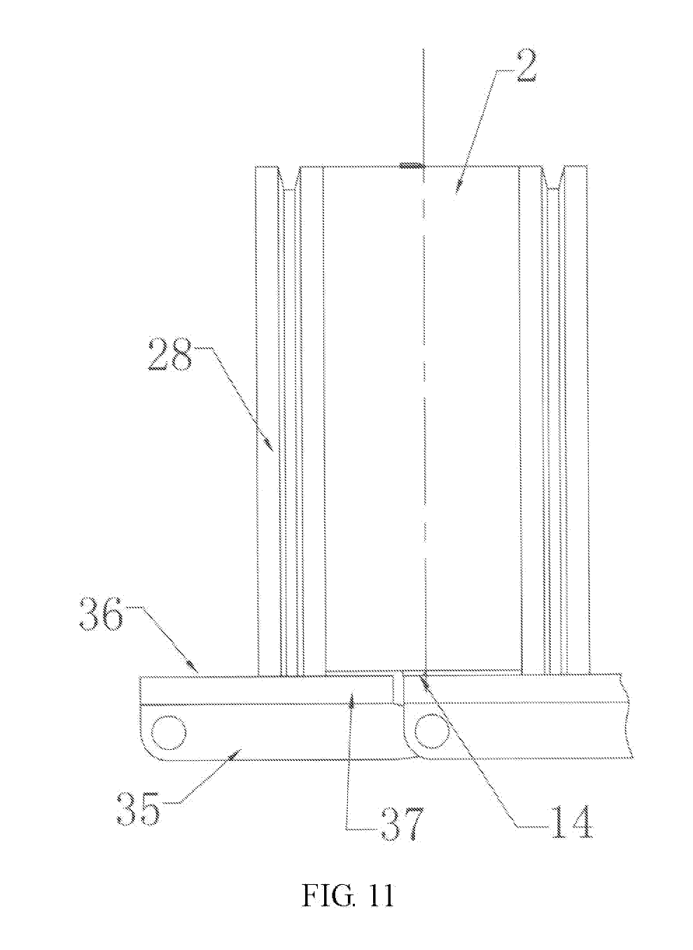

The blade 28 divides the support part 39 into a rectangular front support part 37 and a rear support part 36 for supporting the package 3. The front support part 37 refers to a location of the same chain link 35 upstream (front of) the traveling direction of the annular chain 27 conveying the package, while the rear support part 36 refers to a location of the same chain link 35 downstream (back of) the traveling direction of the annular chain 27 conveying the package. The front end surface of front support part 37 is parallel to the rear end surface of the rear support part 36, and the support surface of the rear support part 36 and the support surface of the front support part 37 are in a same plane. The support surface of the rear support part 36 is perpendicular to the rear end surface thereof and they are in arc transition or slope transition to form a guiding surface for folding the flap at the end 14, the height of the rear end surface equaling to or being slightly larger than the height H of the flap at the end 14. The front support part 37 and the rear support part 36 have different lengths along the path B: the length of the support surface of the front support part 37 L5 equaling to or being slightly smaller than the distance between the flap at the end 14 and the rear side surface of the package 3 L1, so that the flap at the end 14 can enter into a gap 43 between two neighboring chain links 35 when the package 3 is fed from the provision platform 21; accordingly, the length of the support surface of the rear support part 36 L4 equaling to or being slightly larger than the sum of the height H of the flap at the end 14 and the distance between the flap at the end 14 and the front side surface of the package 3 L2. With such a structure of different lengths, since at the top 32a of the C-shaped part 32 corresponding to the provision platform 21 (as shown in FIG. 8-11), there is a gap 43 between the two support parts 39 (the front support part 37 and the rear support part 36) of the annular chain 27, after the package 3 is fed from the provision platform 21, the package 3 is supported by the blade 28 of the next chain link 35 and the flap at the end 14 thereof can enter into the gap 43, during the movement through the chain link 35 from the C-shaped part 32 to the linear top branch 30, the blade 28 of the next chain link 35 pushes the package 3 closer to the blade 28 of the previous chain link 35, the gap 43 thus gradually becomes narrower; and meanwhile, since the flap at the end 14 is blocked by the rear end surface of the rear support part 36 of the previous chain link 35, the flap at the end 14 is gradually withdrawn from the gap 43 and is then folded backward onto the end part 9.

According to the structure of the chain conveyor, the blade 28 is vertically placed at the main part B1 of the path B, and substantially horizontally placed at the provision platform 21 and the output platform 22.

Each package 3 is placed on the conveyor, with the end part 9 contacting the conveying part of the annular chain 27, one side surface of the planar rectangular wall 10 being laid on the blade 28 of the next chain link 35, and the axis A parallel to the blade 28 but crisscross to the path B.

At the provision platform 21, each package 3 is fed to the chain conveyor in the feed direction C coaxial to the axis A of the package 3 and at the horizontal input position of the provision platform 21 where the end part 9 and the relative flap at the end are placed facing the conveying part of the annular chain 27. Similarly, each folded packaging container 2 is removed from the conveyor at a horizontal output position of the output platform 22.

In order to prevent the flap at the end 14 of the package 3 from squeeze damage, when in the straight line segment, there is a gap between the front end surface of the front support part 37 of the chain link 35 and the rear end surface of the rear support part 36 of the neighboring chain link 35, the width of the gap equaling to or being larger than the thickness of the flap at the end 14, the depth of the gap equaling to or being slightly larger than the height of the flap at the end 14.

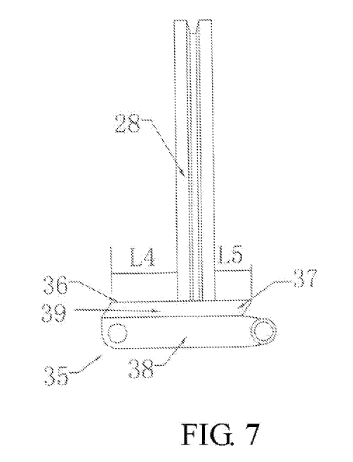

As another embodiment of the present invention, it is different from the above embodiments in that: as shown in FIG. 7, the rear end surface of the rear support part 36 tilts towards a direction away from the blade 28 to form a guiding surface for folding the flap at the end 14, and the rear end surface tilts in such a way that the included angle formed between the support surface of the rear support part 36 and the rear end surface thereof is 90°-135°, and the projection height of the rear end surface of the rear support part 36 perpendicular to the support surface thereof equals to or is slightly larger than the height H of the flap at the end 14 so that the flap at the end 14 can be fully accommodated within the gap 43.

Certainly, the purpose of the present invention may also be realized if an acute angle is formed between the support surface of the rear support part 36 and the rear end surface thereof.

What is claimed is:

1. A chain conveyor, comprising a hinge part for hinging and a support part fastened onto the hinge part for supporting a package, the support part being fastened with a blade for clamping and pushing the package, the blade dividing the support part into a rectangular front support part and a rear support part, and multiple chain links being able to be hinged to form an annular chain, with a distance between the blades of two neighboring chain links in a straight line segment equaling to the width of the package, characterized in that the length of the support surface of the front support part equals to or is slightly smaller than distance between the flap at the end and the rear side surface of the package; and the rear end surface of the rear support part forms a guiding surface for guiding the folding of the flap at the end.

2. The chain conveyor of claim 1, characterized in that the length of the support surface of the rear support part is slightly larger than the sum of height of the flap at the end and distance between the flap at the end and the front side surface of the package.

3. The chain conveyor of claim 2, characterized in that the support surface and the rear end surface of the rear support part are in arc transition or slope transition.

4. The chain conveyor of claim 2, characterized in that the support surface of the rear support part is perpendicular to the rear end surface thereof, the height of the rear end surface equaling to or being slightly larger than height of the flap at the end.

5. The chain conveyor of claim 2, characterized in that the rear end surface of the rear support part tilts towards a direction away from the blade to form a guiding surface for folding the flap at the end.

6. The chain conveyor of claim 5, characterized in that an included angle between the support surface of the rear support part and rear end surface thereof is 90°-135°.

7. The chain conveyor of claim 5, characterized in that a projection height of the rear end surface of the rear support part perpendicular to the support surface thereof equals to or is slightly larger than height H of the flap at the end.

8. The chain conveyor of claim 1, characterized in that the support surface of the rear support part and rear end surface thereof form an acute angle.

9. The chain conveyor claim 1, characterized in that the front end surface of the front support part is parallel to the rear end surface of the rear support part.

10. A filling machine, comprising the chain conveyor of claim 1.

11. A method for folding a flap at the bottom end of a package, comprising the annular chain formed of multiple chain links hinged of claim 1, the annular chain comprising a horizontal linear top branch and a bottom branch and two bent C-shaped parts, the C-shaped parts being located at two ends of the top branch and the bottom branch respectively, and the middle parts of the C-shaped parts defining a provision platform and an output platform respectively, the method comprising the following steps:
A. a package having an flap at the end is fed from the provision platform and the flap at the end is allowed to enter into a gap between two neighboring chain links;
B. the annular chain is turned around, and the blade of the next chain link is allowed to push the package to move towards the top branch, such that;
C. a guiding member on the C-shaped part at the provision platform flattens ends of the package; and
D. the rear end surface of the rear support part gradually guides the flap at the end to be folded onto the end part.
